(19) United States
(12) Patent Application Publication
(10) Pub. No.: US 2014/0111356 A1
(43) Pub. Date: Apr. 24, 2014

(54) RAILWAY TANK CAR SECURITY DEVICE

(71) Applicants: William LeFebvre, West Chester, PA (US); Andrew Martin, West Chester, PA (US); Matt Bonnes, West Chester, PA (US)

(72) Inventors: William LeFebvre, West Chester, PA (US); Andrew Martin, West Chester, PA (US); Matt Bonnes, West Chester, PA (US)

(73) Assignee: AMSTED RAIL COMPANY, INC., Chicago, IL (US)

(21) Appl. No.: 13/659,436

(22) Filed: Oct. 24, 2012

(51) Int. Cl. G08G 1/127

(52) U.S. Cl. CPC G08G 1/127
USPC 340/988

(57) ABSTRACT

A railcar sensing system is provided that in particular provides a system for sensing the orientation of a hatch of a railway tank car. The railcar sensing system includes an accelerometer for sensing the orientation of the hatch, a position sensing device for detecting the global position of the railcar, and a processing unit. The accelerometer sends a first signal to the processing unit when the orientation of the hatch changes more than a predetermined angle. The processing unit also senses whether the railway tank car is outside one of the preselected safe zones. If the railway tank car is located outside one of the preselected safe zones, and the accelerometer senses that the hatch orientation has been changed more than a predetermined angle, an alert signal is sent to a receiver indicative of such event.

### BACKGROUND OF THE INVENTION

The present invention relates to a railcar sensing system and, more particularly, to a sensing system that monitors the hatch on a railway tank car. Further, global positioning data for the railcar is also sensed and utilized in the system.

It has become more important for owners and operators of railway freight cars and tank cars to be able to locate such railcars on a near real time basis. Further, from a security point of view, it is important for railway tank car operators to determine whether the hatch of such railway tank cars is open. The significance of such hatch being open on railway tank cars is that the hatch provides access to the piping for loading and unloading the contents of the tank car.

It is also an important consideration that the location of such railway freight cars and tank cars be taken into consideration when monitoring and sensing operating parameters such as the hatch on a tank car being open or closed. For example if a railway tank car is in a safe location, such as on the owner's premises and is undergoing a normal loading or unloading operation, it would be desirable not to receive a warning signal that the hatch has been opened or closed. Such additional performance characteristics of a system would decrease the number of warning signals to be processed.

### SUMMARY OF THE INVENTION

Accordingly, it is an object of the present invention to provide a railcar sensing system that will monitor the location and hatch condition of a railway tank car.

It is a further object of the present invention to provide a railcar sensing system that monitors the location and hatch condition of the railway tank car, and compares the location of the railway tank car with a preselected series of safe locations.

It is a further object of the present invention to provide a railcar sensing system and, in particular, a railway tank car hatch condition monitoring system that provides a warning signal when the railway tank car is outside a certain preselected safe location and the hatch condition changes beyond a predetermined amount.

In one embodiment of the present invention, the railcar sensing system includes an accelerometer which is mounted on the hatch of the railway tank car. The accelerometer senses the orientation of the hatch with relation to the direction of gravity. The accelerometer sends a signal to a processing unit that is indicative of a change in orientation of the hatch more than a predetermined amount. A position sensing device is also part of the railcar sensing system of this embodiment of the present invention. The position sensing device detects the global position of the railcar and sends a signal representative of such position to the processing unit.

The processing unit sends a signal to a transmitting unit upon receipt of the signal from the accelerometer that the railway car hatch has been moved more than the predetermined amount. The processing unit also sends and compares the global position of the railcar to determine whether the railcar is within certain preselected safe zones. Such safe zones could correspond to usual loading and unloading locations for the railcar that would be stored in the processing unit. If the railcar is outside any of the preselected safe zones, the processing unit sends a signal to a transmitting unit which in turn sends a signal to a communication device that the railway tank car hatch orientation has changed more than a predetermined amount and that the railcar is outside of the preselected safe zone.

### BRIEF DESCRIPTION OF THE DRAWINGS

In the drawings,

FIG. 1 is a block diagram outlining the system in accordance with an embodiment of the present invention;

FIG. 1A are detailed block logic diagrams of a railcar sensing system in accordance with an embodiment of the present invention;

FIG. 2 is a partial perspective view of a railcar sensing system with an embodied structure mounted to the hatch of a railway tank car, and

FIG. 3 is a perspective view of a railway tank car with a railcar sensing system installed on a hatch thereof.

### DETAILED DESCRIPTION OF THE INVENTION

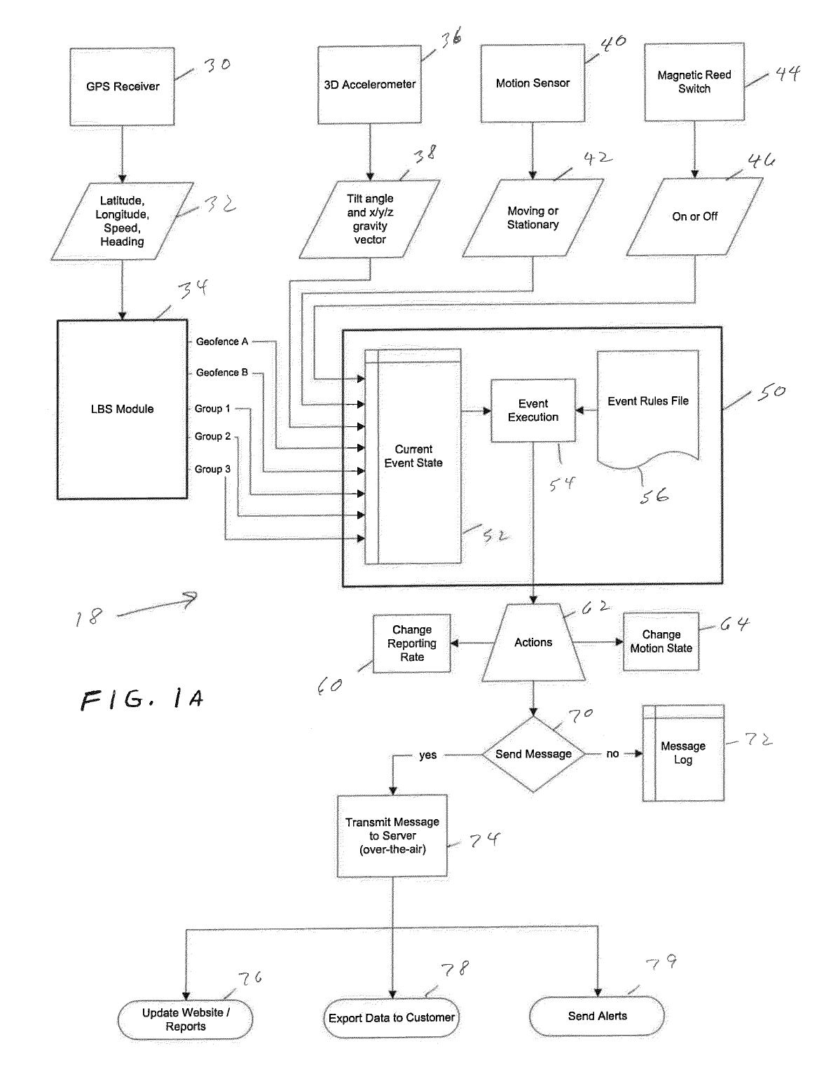

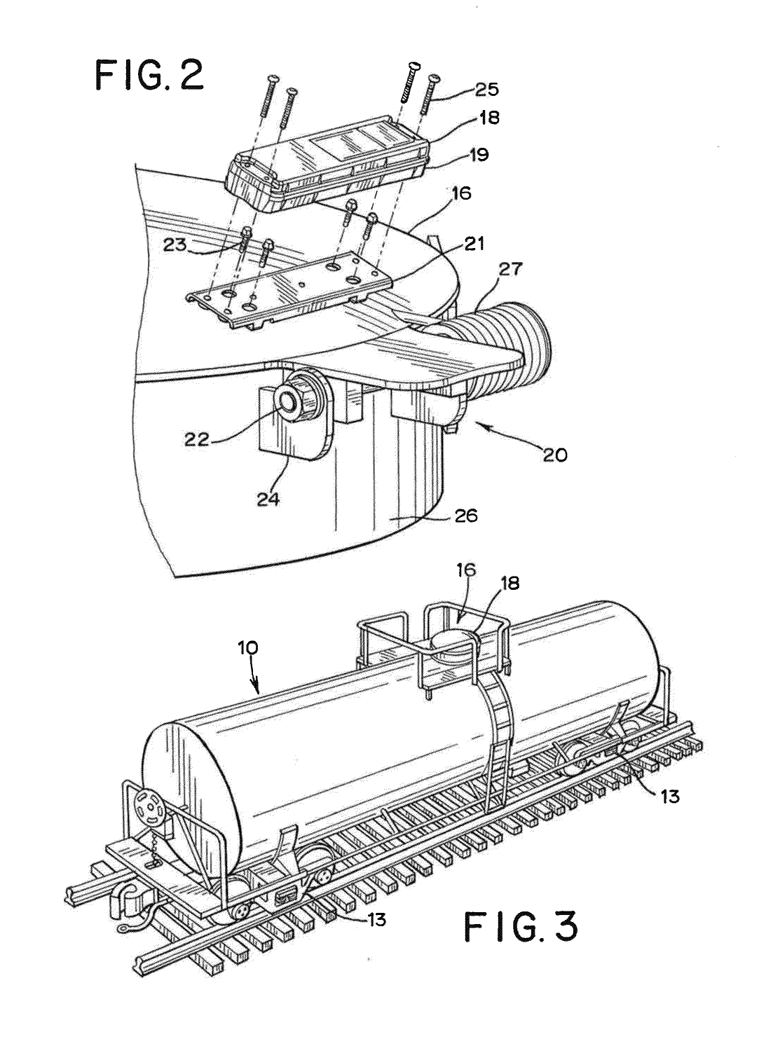

Referring now to FIG. 2 and FIG. 3 of the drawings, a railway tank car is shown generally at 10. Such railway tank car is comprised of the usual tank car body supported on longitudinally spaced railcar trucks 13. Railway tank car 10 includes a top mounted hatch 16. Hatch sensing body structure 18, which is a generally rectangular structure, is mounted directly to hatch 16 in this embodiment of the present invention. As shown in detail in FIG. 2, a sensing device mounting bracket 21 is affixed directly to hatch 16 using self tapping mounting screws 23 or other equivalent metal mounting screws. Hatch sensing body structure 18 is seen to comprise a rectangular sensing body unit 19 which is affixed to sensing mounting bracket 21 utilizing secure fasteners 25 which could be specially designed machine screws or similar screw like or bolt like devices.

Hatch 16 is a generally cylindrical structure, which fits on top of generally cylindrical hatch support 26 which itself extends upwardly from the top surface of railway tank car 10. Hatch hinge assembly 20 is comprised of hatch mounting hinges 24 which are affixed usually by welding to hatch support 26. Hatch hinge assembly 20 also comprises hatch hinge pin 22 which usually comprises an elongated machine bolt that extends through openings in hatch mounting hinges 24.

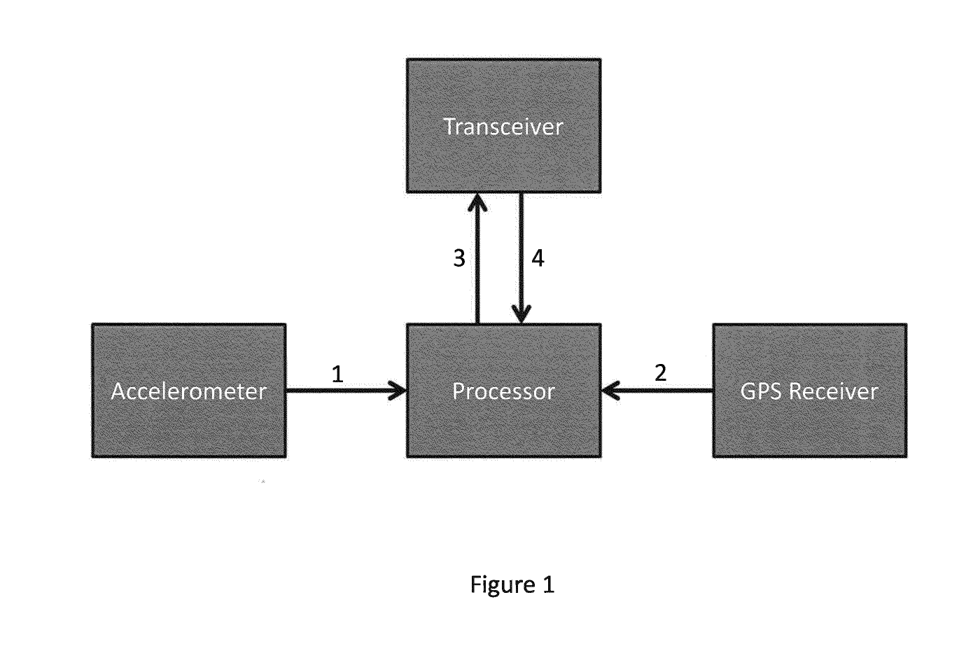

Referring now to FIG. 1, of the drawings, a block diagram outlining the communication of components used to process incoming information from the environment in which the tan car resides.

The processor collects data from the accelerometer (1) indicating that a hatch open or dosed event has occurred. It then collects GPS data (2) to associate the hatch event to a specific location. The processor then determines if the event needs to be transmitted (3) to an external server and received an acknowledgement (4) that the event has been successfully received.

Referring now to FIG. 1A of the drawings, a logic diagram setting forth an operating embodiment of the railcar sensing system of the present invention is set forth.

A global positioning system receiver is shown at 30 which detects and provides a signal representative of the global position of the railway tank car 10. Sensing information 32 is also present which contains data from the global positioning sensing receiver 30 and also contains the speed and directional heading of railway tank car 10. This information is then sent to location processing module 34. Location processing module 34 has preselected geographic safe areas loaded therein. The global position of railcar 10 is compared within location processing module 34 to determine if railcar 10 is inside or outside any of the preselected safe geographic areas or zones. Such predetermined geographic areas or safe zones are typically customer locations wherein railway tank car 10 is typically loaded or unloaded and it could be expected that hatch 16 would be open when within such safe zones. Further, the significance of hatch 16 being open in that the piping associated and necessary for the loading and unloading of railway tank car 10 is located within hatch 16.

Accelerometer unit 36 is also a component of the railcar sensing system of this embodiment of the present invention and is also located within hatch sensing body structure 18, as is global positioning receiver 30 and location processing module 34. Accelerometer unit 36 senses the alignment of hatch 16 with regard to the orientation in relation to the direction of gravity. Tilt angle and gravity vector information 38 contains data from accelerometer 36 which determines if hatch 16 has been moved more than a preselected amount. If hatch 16 has been moved or rotated about hinges 24 more than the preselected amount, a representative signal is sent from angle sensing unit 38 to central processing unit 50.

A motion sensor 40 could also be a component of railcar sensing system of this embodiment of the present invention. Such motion sensor 40 would, when combined with a motion sensing parameter storage location 42, provide a signal to central processing unit 50 whether a railway tank car 10 is in motion or stationary.

Another possible component of the railcar sensing system in accordance with the present invention, is a magnetic reed switch 44 that is combined with an on off unit 46 which together can be activated from a signal from central processing unit 50 on whether to sense or not sense motion of hatch 16.

Central processing unit 56 includes a current events state unit 52 which receives signals from location processing module 34, accelerometer and angle sensing unit 36 and 38, and possibly also motion sensor units 40 and 42 and magnetic reed switch units 44 and 46. Event state unit 52 compares the signal from location processing module 34 and determines whether railway tank car 10 is within or outside a preselected safe zone. Such preselected safe zone would usually be a customer selected loading or off loading location that is a preselected and stored within the railcar sensing system. If railway tank car 10 is within a safe zone, and a signal is received from accelerometer 36 and angle sensing unit 38 that hatch 16 has been moved or opened more than a predetermined amount, such signal will be processed by event state unit 52 and sent to event execution unit 54 which has preselected instructions from event rules unit 56. Such event rules unit 56 could be utilized to preselect safe zones or acceptable angles of hatch 16 movement. Event execution unit 54 would accordingly send a signal to action comparator unit 62 which has acknowledged that railway tank car 10 is within a safe zone. Accordingly, action comparator unit 62 would send an appropriate message to transmitting comparator 70 that railway tank car 10 is within a safe zone and that no alarm message would be sent, but rather a message would be sent to message log 72 that although hatch 16 has been moved or opened more than the preselected amount, as railway tank car 10 is within a safe zone, no alarms signal is needed. However, if railway tank car 10 is outside a preselected safe zone, event state unit 52 would receive such location information from location processing module 34, and upon receipt of a signal from accelerometer 36 that hatch 16 has been moved or opened more than a preselected amount, event state table 52 would send a signal to event execution unit 54 that such hatch 16 movement or opening has occurred. Accordingly, event execution unit 54 would send a signal to action comparator unit 62 which would in turn send a signal to transmitting comparator 70 that hatch 16 has been moved or opened more than a preselected amount, and that an alarm message must be sent to and would be sent to communication unit 74. Communication unit 74 in turn can provide a variety of messages including an update on a customer website 76, data of railway tank car 10 location and that hatch 16 has been moved or opened more than a preselected amount, as well as an alarm or alert message 79.

It is also noted that the change that reporting rate to determine the processing rate to sense both the global position of railway tank car 10 and any movement or opening of hatch 16 can be adjusted through reporting rate unit 60.

The following are two examples of operation of the railcar sensing system of the present invention.

### Example 1

In this is event hatch 16 opened inside a safe zone or customer facility, with the result being that a message is sent to the system but that an alert message is not sent. Accelerometer 36 detects a tilt angle of 50 degrees which is above a preselected limit for hatch movement. Such hatch tilt state is updated in the event state unit 52. Global positioning system 30 acquires the location of railway tank car 10 and delivers a signal indicative of such position to location processing module 34. Location processing module 34 compares and determines if the location of railway tank car 10 is within a preselected safe zone. In this case, railway tank ear 10 is within a preselected safe zone or customer site. Such signal is compared with an event rules location from event rules unit 56 with a signal to event execution unit 54. The result is a signal will be sent to action comparator unit 62 resulting in a message from transmitting comparator 72 message log 72 that is not considered an alert.

### Example 2

In this event, hatch 16 is open outside of safe zone or customer facility resulting in an alert signal. The steps in such example are as follows. Motion sensor 40 and 42 sense that railway tank car 10 is stationary. Global positioning system receiver 30 senses the global position of railway tank car 10 and provides a location signal to location processing module 34. Location processing module 34 compares the global position of railway tank car 10 with the preselected safe zones or customer sites. It is determined that railway tank car 10 is outside such safe zones. Accelerometer 36 detects that hatch 16 has tilted 50 degrees, which is above a preselected threshold. Such accelerometer 36 sends a signal to event state unit 52 which compares such movement of hatch 16 with the position of railway tank car 10 against data stored in the event rules unit 56. Because it has been determined that railway tank car 10 is outside a safe zone or customer site, event execution unit 54 sends a signal to action comparator unit 62 that hatch 16 has moved or been opened more than a preselected angle, and that railway tank car 10 is outside a preselected safe zone or customer site. Accordingly action comparator unit 62 sends a signal to transmitting comparator 70 which in turn sends a signal to communication unit 74. Communication 74 then will in turn send one or more signals which could include a customer website update or report, a data signal to customer 78, or an alert to customer 79 which could take various forms such as an email or telephone call.

What is claimed is:

1. A railcar sensing system comprising:
a railcar including a hatch,
an accelerometer for sensing the orientation of the hatch with relation to the direction of gravity,
a processing unit with an event engine,
a position sensing device for detecting the global position of the railcar,
and sending a position sensing signal to the processing unit
the accelerometer sending a first signal to the processing unit when the orientation of the hatch changes more than a pre-determined amount,
against a known closed position
as determined by the event engine,
a transmitting unit,
the processing unit sending a second signal to the transmitting unit upon receipt of the first signal from the accelerometer,
a receiver,
the transmitting unit sending a third signal to the receiver or server indicating that the orientation of the hatch has changed.

2. The railcar sensing system of claim 1
further comprising a body structure containing the accelerometer,
the processing unit,
the position sensing device, and
the transmitting unit.

3. The railcar sensing system of claim 2
further comprising a power source contained in the body structure.

4. The railcar sensing system of claim 1
wherein the position sensing device further detects the speed and direction of travel of the railcar,
and the position sensing signal sent to the processing unit includes the speed and direction of travel of the railcar,
and the third signal sent to the receiver includes the speed and direction of travel of the railcar.

5. The railcar sensing system of claim 2
wherein the body structure is attached to the hatch of the railcar.

6. The railcar sensing of claim 1
wherein upon receipt of the position sensing signal,
the processing unit analyzes the position sensing signal to determine if the railcar is located outside of a predetermined safe zone,
and using the event engine within the processing unit to determine if a second signal should be sent to the transmitting unit.

7. A railcar sensing system comprising
a railcar including a hatch,
an orientation sensing device for sensing the orientation of the hatch,
a central processing unit,
a position sensing device for sensing the global positions of the railcar and for sending a first signal to the central processing unit representative of the global position of the railcar,
the orientation sensing device sending a second signal to the central processing unit when the orientation of the hatch changes,
a transmitting unit,
the central processing unit analyzing the second signal from the orientation sensing device to determine if the orientation of the hatch changed more than a preselected limit determined by the event engine,
the central processing unit sending a third signal to the transmitting unit if the orientation of the hatch changed more than the preselected limit.

8. The railcar sensing device of claim 7
wherein upon receipt of the first signal,
the central processing unit analyzes the first signal to determine if the railcar is located within a safe zone predetermined by the event engine,
and if the railcar is located within the safe zone,
the central processing unit does not send the third signal to the transmitting unit if the orientation of the hatch changed more than the preselected limit.

9. The railcar positioning system of claim 7,
further comprising a body structure containing
the accelerometer,
the processing unit,
the position sensing device,
and the transmitting unit.

10. The railcar sensing system of claim 7
wherein the position sensing device
further detects the speed and direction of travel of the railcar,
and the first signal sent to the central processing unit includes the speed and direction of travel of the railcar.

11. A railcar sensing system comprising
a railcar including a hatch,
a position sensor for determining the global position of the railcar,
a location processor,
the position sensor sending a first signal to the location processor,
the location processor determining whether the railcar is located outside of one of certain predetermined safe zones,
a central processor,
an accelerometer for sensing the orientation of the hatch,
the accelerometer sending a second signal to the central processor when the orientation of the hatch changes more than a predetermined amount determined by the event engine,
a transmitter,
the central processor sending a third signal to the transmitter upon receipt of the first signal from the central processor if the railcar is located outside of one of the preselected safe zones.

12. The railcar sensing system of claim 11 further comprising a receiver,
the transmitter sending a fourth signal to the receiver indicating that the orientation of the hatch has changed.

13. The railcar sensing system of claim 11
further comprising a body structure containing a position sensor,
the location processor,
the central processor,
the accelerometer,
and the transmitter.

14. The railcar sensing system of claim 13
wherein a power source is contained in the body structure.

15. The railcar sensing system of claim 12
wherein the position sensor further detects the speed and direction of travel of the railcar,
and the first signal sent to the location processor includes the speed and direction of travel of the railcar,
and the fourth signal sent to the receiver includes the speed and direction of travel of the railcar.

16. The railcar sensing device of claim 13
wherein the body structure is attached to the hatch of the railcar.

17. The railcar sensing system of claim 11
utilizing polygons to define safe zones and determine if the railcar is inside or of outside the safe zone.

18. The railcar sensing system of claim 12
wherein the transmitter sends the fourth signal to the receiver to create an alert when the event engine determines alert conditions have been met based on predetermined event rules.
